(19) United States
(12) Patent Application Publication
(10) Pub. No.: US 2017/0243529 A1
(43) Pub. Date: Aug. 24, 2017

(54) SOURCE DRIVER, DISPLAY DEVICE, DELAY METHOD OF SOURCE OUTPUT SIGNAL, AND DRIVE METHOD OF DISPLAY DEVICE

(71) Applicant: AU Optronics Corporation, HSIN-CHU (TW)

(72) Inventors: Chih-Hao HUNG, HSIN-CHU (TW); Hung-Chi WANG, HSIN-CHU (TW); Chih-Hsiang YANG, HSIN-CHU (TW)

(21) Appl. No.: 15/403,575

(22) Filed: Jan. 11, 2017

(30) Foreign Application Priority Data
Feb. 24, 2016 (TW) 105105482

(51) Int. Cl. G09G 3/20

(52) U.S. Cl. CPC G09G 3/2092; G09G 2320/04

(57) ABSTRACT

A drive method for a source signal including: acquiring a transmitting delay time of a gate signal; generating a plurality of delayed trigger signal according to the transmitting delay time of the gate signal, and sequentially outputting a plurality of delayed source signal to a plurality of pixel circuit according to the delayed trigger signal.

### BACKGROUND

Technical Field

The present application relates to an electronic device and method, and more particularly to a source driver, a display device, a delay method of a source output signal and a drive method of a display device.

Related Art

With development of science and technology, display devices have been widely used in people's life.

A typical display device may include a gate driver and a source driver. The gate driver is used for providing a gate signal to an active region, to turn on a pixel circuit of the active region. The source driver is used for providing a source output signal to the turnned pixel circuit in the active region, to display the pixel circuit in the active region corresponding to the voltage of the source output signal.

However, the gate signal may be attenuated during transmission, resulting in that the gate signal has different transmitting delay times in different positions on the gate line. As a result, it is not easy for the source output signal to cooperate with the gate signal for output, leading to operational errors of the display device.

### SUMMARY

One implementation aspect of the present application relates to a source driver of a display device. According to one embodiment of the present application, the source driver of a display device includes: a comparison module, a control module and an output module. The comparison module is used for acquiring a transmitting delay time of a gate signal. The control module is used for generating a plurality of delayed trigger signals according to the transmitting delay time of the gate signal. The output module is used for outputting a plurality of delayed source output signals to a plurality of pixel circuits sequentially according to the delayed trigger signals.

Another implementation aspect of the present application relates to a display device. According to one embodiment of the present application, the display device includes: a plurality of pixel circuits, a gate driver and a plurality of source drivers. The gate driver is used for outputting a gate signal. At least one of the source drivers includes: a comparison module, a control module and an output module. The comparison module is used for acquiring a transmitting delay time of a gate signal. The control module is used for generating a plurality of delayed trigger signals according to the transmitting delay time of the gate signal. The output module is used for outputting a plurality of delayed source output signals to the pixel circuits sequentially according to the delayed trigger signals.

Another implementation aspect of the present application relates to a source driver of a display device. According to one embodiment of the present application, the source driver of a display device includes a comparison module, a control module and an output module. The comparison module is used for acquiring a transmitting delay time of a gate signal. The control module is used for obtaining an estimated time point when a rising edge of the gate signal reaches a first threshold on an operating point of a gate line according to the transmitting delay time of the gate signal. The output module is used for outputting a delayed source output signal to a pixel circuit at the estimated time point. The pixel circuit is turned on corresponding to the gate signal on the operating point of the gate line, to be charged according to the delayed source output signal.

Another implementation aspect of the present application relates to a delay method of a source output signal. According to one embodiment of the present application, the delay method includes: receiving a gate signal, for detecting a rising edge and a falling edge of the gate signal; and when a voltage corresponding to the rising edge reaches a threshold voltage, outputting a pixel voltage to the display.

By application of the one embodiment, the source output signal can be output corresponding to the transmitting delay time of the gate signal, to reduce the risk of operational errors of the display device. All of the modules can be implemented with a circuit or a software executed by a circuit.

### BRIEF DESCRIPTION OF THE DRAWINGS

FIG. 1 is a schematic diagram of a display device drawn according to one embodiment of the present application;

FIG. 2 is a schematic diagram of a display device drawn according to one embodiment of the present application;

FIG. 3 is a schematic diagram of a source driver drawn according to one embodiment of the present application;

FIG. 4 is a schematic diagram of a source driver drawn according to one embodiment of the present application;

FIG. 5 is a schematic diagram of a signal of a source driver drawn according to one embodiment of the present application;

FIG. 6 is a schematic diagram of a display device drawn according to one embodiment of the present application; and

FIG. 7 is a flowchart of a delay method of a source output signal drawn according to one embodiment of the present application.

### DETAILED DESCRIPTION

The spirit of the disclosure is clearly described below with reference to the accompanying drawings and detailed statement; any person of ordinary skill in the art can make changes and modifications according to the technology taught by the disclosure after understanding embodiments of the disclosure, which do not depart from the spirit and scope of the disclosure.

The terms “first”, “second”, . . . and the like used herein neither particularly refer to an order or a sequence nor are used to limit the present invention, which are merely intended to distinguish elements or operations described with the same technical terms.

The expression “electrical coupling” used herein may refer to that two or more elements make physical or electrical contact with each other directly or indirectly, and the expression “electrical coupling” may also refer to that two or more elements inter-operate or interact.

The expressions “comprise”, “include”, “have” and the like used herein are open terms, which mean including but not limited to.

The expression “and/or” used herein includes any one or all of combinations of the objects.

Direction terms used herein, for example, up, down, left, right, front, back and the like, merely make reference to directions in the accompanying drawings. Therefore, the direction terms used are used to describe instead of limiting the present application.

The terms used herein, otherwise specifically noted, generally have a common meaning of each term used in the disclosure and special content in this field. Some terms used for describing the disclosure are discussed hereinafter or in other parts of the specification, to provide additional guidance for the description about the disclosure by persons skilled in the art.

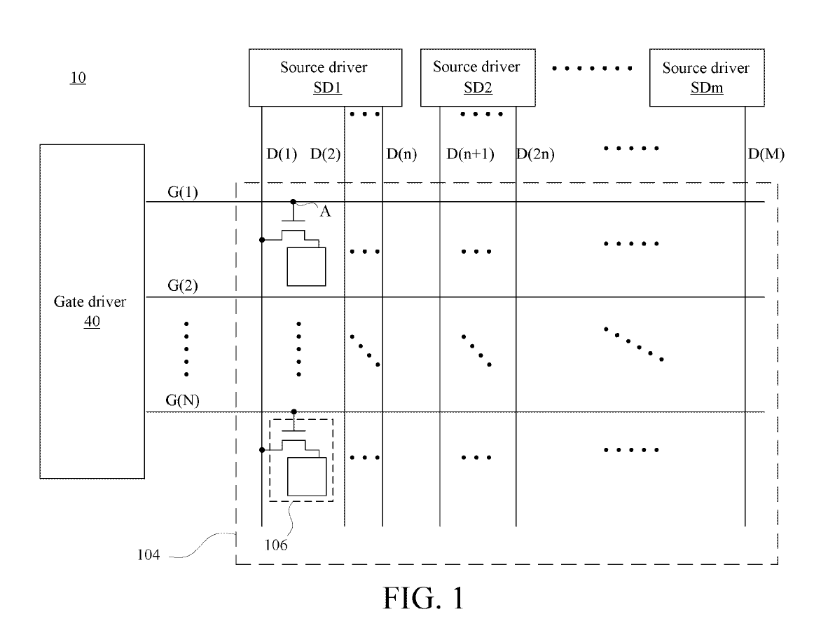

FIG. 1 is a schematic diagram of a display device 10 drawn according to one embodiment of the present application. In this embodiment, the display device 10 includes an active region 104, source drivers SD1, SD2, . . . , SDm, and a gate driver 40. The active region 104 includes a plurality of pixel circuits 106 arranged in the form of an array. In this embodiment, the gate driver 40 provides gate signals G(1), G(2), . . . G(N) to the pixel circuits 106 row by row, to turn on transistors in the pixel circuits 106 row by row. The source drivers SD1, SD2, . . . , SDm provide source output signals D(1), D(2), . . . , D(M) to the pixel circuits 106 where the transistors are turned on, to display the pixel circuits 106 corresponding to the source output signals D(1), D(2), . . . , D(M).

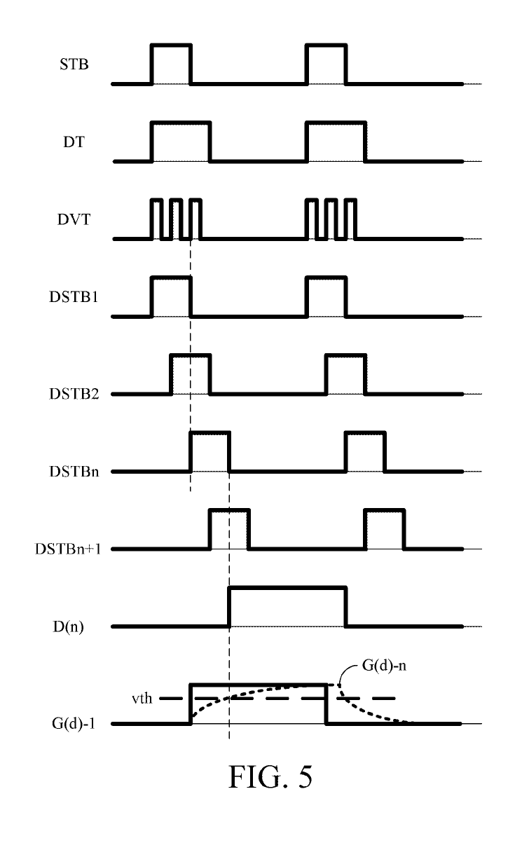

In this embodiment, based on the RC delay effect, the gate signals G(1), G(2), . . . G(N) may be attenuated with distances transmitted on a gate line, causing the same gate signal (e.g., the gate signal G(1)) to have different delay times in different positions on the gate line. That is, times when rising edges of a gate signal (equivalent to the gate signal G(d)-1 in FIG. 5) in a position adjacent to the gate driver 40 on the gate line and a gate signal (equivalent to the gate signal G(d)-n in FIG. 5) in a position away from the gate driver 40 on the gate line reach a threshold voltage vth are different from each other. In one embodiment, the threshold voltage vth may be 0.7 V, but other values may also fall within the scope of the present application due to different actual processes. In one embodiment of the present application, the source driverss SD1, SD2, . . . , SDm may detect rising edges and falling edges of the gate signals G(1), G(2), . . . G(N), and when the rising edges of the gate signals G(1), G(2), . . . G(N) reach a threshold voltage (e.g., the threshold voltage vth in FIG. 5), the source output signals D(1), D(2), . . . , D(M) (i.e., pixel voltages) are output to the active region 104 (i.e., display) of the display device 10. As a result, operational errors of the display device 10 due to non-alignment of the gate signals G(1), G(2), . . . G(N) with the source output signals D(1), D(2), . . . , D(M) caused by delay of the gate signals G(1), G(2), . . . G(N) can be reduced.

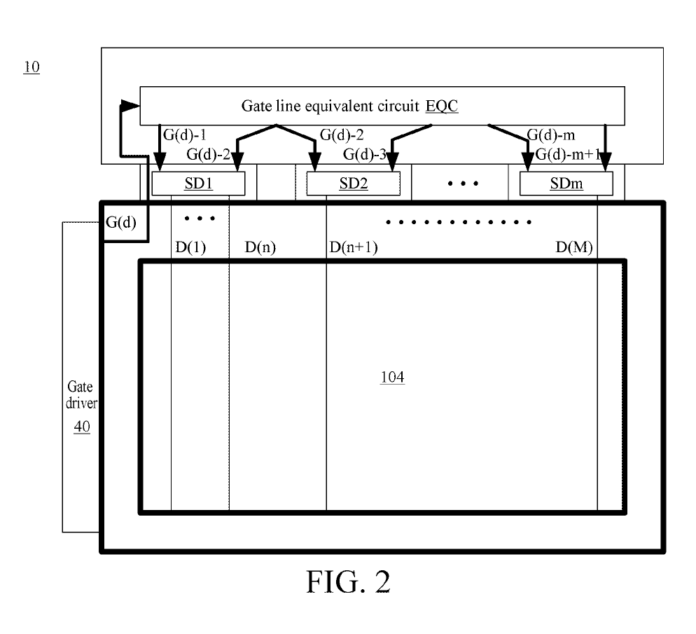

Referring to FIG. 2 at the same time, in this embodiment, the display device 10 further includes a gate line equivalent circuit EOC. The gate line equivalent circuit EOC is used for being equivalent to the RC delay effect of the gate line on the display device 10. In one embodiment, the gate line equivalent circuit EOC can be implemented with a capacitor and a resistor. In one embodiment, the gate line equivalent circuit EOC receives a gate signal G(d) output by the gate driver 40, to generate delayed gate signals G(d)-1, G(d)-2, . . . , G(d)-m+1, and outputs the delayed gate signals G(d)-1, G(d)-2, . . . , G(d)-m+1 to the source drivers SD1, SD2, . . . , SDm. For example, the gate line equivalent circuit EOC outputs the delayed gate signals G(d)-1 and G(d)-2 to the source driver SD1, outputs the delayed gate signals G(d)-2 and G(d)-3 to the source driver SD2, and outputs the delayed gate signals G(d)-m and G(d)-m+1 to the source driver SDm, wherein times when rising edges of the delayed gate signals G(d)-1, G(d)-2, . . . , G(d)-m+1 reach the threshold voltage vth in FIG. 5 are different from each other. In this embodiment, the gate signal G(d) may be a pseudo signal, that is, it is used for making the source drivers SD1, SD2, . . . , SDm know signal delay conditions on the gate line, but is neither used for being provided to the pixel circuits 106 nor used for turning on the transistors of the pixel circuits 106.

In this embodiment, the source drivers SD1, SD2, . . . , SDm may respectively acquire transmitting delay times of the gate signal G(d) in the corresponding region according to two groups of delayed gate signals received. According to the transmitting delay times, the source drivers SD1, SD2, . . . , SDm can output the source output signals D(1), D(2), . . . , D(M) to the pixel circuits 106 (the route as shown in FIG. 1) corresponding to the delayed gate signals G(d)-1, G(d)-2, . . . , G(d)-m+1.

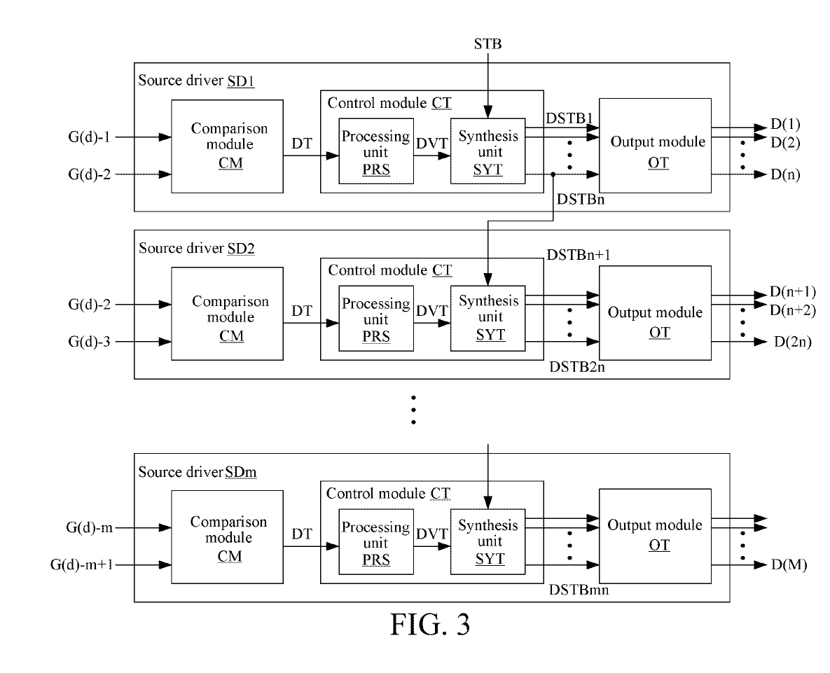

Specifically, referring to FIGS. 3-5, in this embodiment, each of the source driver SD1, SD2, . . . , SDm includes a comparison module CM, a control module CT and an output module OT. In this embodiment, the control module CT is electrically connected between the comparison module CM and the output module OT. In this embodiment, the control module CT includes a processing unit PRS and a synthesis unit SYT. The processing unit PRS and the synthesis unit SYT are electrically connected with each other.

In this embodiment, the comparison module CM of the source driver SD1 receives the delayed gate signals G(d)-1 and G(d)-2, and outputs a delay time signal DT corresponding to a transmitting delay time of the delayed gate signals G(d)-1 and G(d)-2 (i.e., the time difference between the gate signals G(d)-1 and G(d)-2 to the control module CT. The transmitting delay time, for example, corresponds to the time when the delay time signal DT is a high voltage level (refer to FIG. 5). In other words, the comparison module CM of the source driver SD1 is used for comparing a gate signal at different positions in the gate line equivalent circuit EOC, to acquire a transmitting delay time of the gate signal.

In this embodiment, the control module CT is used for receiving a trigger signal STB transmitted by a time sequence controller (not shown), and according to the delay time signal DT and the original trigger signal STB, generating a plurality of delayed trigger signals DSTB1, DSTB2, . . . , DSTBn. In one embodiment, the control module CT may use the processing unit PRS to receive the delay time signal DT, divide the transmitting delay time of the gate signals G(d)-1 and G(d)-2 into a plurality of divided delay times, and output a corresponding divided delay time signal DVT, wherein the divided delay times may correspond to the time when the divided delay time signal DVT is a high voltage level (refer to FIG. 5). In one embodiment, the delay time signal DT may be input to the control module CT corresponding to a clock signal generated inside the source driver SD1 or a pull clock signal.

Afterwards, the control module CT may use the synthesis unit SYT to receive the original trigger signal STB, and delay the original trigger signal STB respectively according to the divided delay times corresponding to the divided delay time signal DVT, to generate the delayed trigger signals DSTB1, DSTB2, . . . , DSTBn to the output module OT.

In another perspective, the control module CT is used for obtaining an estimated time point when a rising edge of the gate signal reaches the threshold voltage vth on a plurality of operating points (e.g., the operating point A in FIG. 1) of the pixel circuits 106 on the gate line according to the transmitting delay time of the gate signals G(d)-1 and G(d)-2. In one embodiment, the control module CT may use the processing unit PRS to divide the transmitting delay time of the gate signals G(d)-1 and G(d)-2 into a plurality of divided delay times, and output corresponding divided delay time signal DVT. Afterwards, the control module CT may use the synthesis unit SYT to receive the original trigger signal STB, and delay the original trigger signal STB respectively according to the divided delay times, to generate the delayed trigger signals DSTB1, DSTB2, . . . , DSTBn to the output module OT, wherein the delayed trigger signals DSTB1, DSTB2, . . . , DSTBn correspond to the estimated time point when a rising edge of the gate signal reaches the threshold voltage vth on a plurality of operating points of the pixel circuits 106 on the gate line.

In addition, the synthesis unit SYT of the source driver SD1 is also used for outputting the delayed trigger signal DSTBn to the synthesis unit SYT of a secondary source driver SD2, to make the synthesis unit SYT of the secondary source driver SD2 delay the trigger signal DSTBn respectively according to the corresponding delay time, to generate the delayed trigger signals DSTB1, DSTB2, . . . , DSTBn to the corresponding output module OT. The rest can be done in the same manner.

In this embodiment, the output module OT is used for outputting the plurality of delayed source output signals D(1), D(2), . . . , D(M) to the pixel circuits 106 sequentially according to the delayed trigger signals DSTB1, DSTB2, . . . , DSTBn at the estimated time point. As a result, it is feasible to, when the pixel circuits 106 are turned on corresponding to the gate signal on the operating point of the gate line, accurately charge the pixel circuits 106 according to the delayed source output signals D(1), D(2), . . . , D(M), to make the display device 10 display the screen correctly.

For example, particularly referring to FIG. 5, when the rising edge of the delayed gate signal G(d)-n corresponding to a particular operating point reaches the threshold voltage vth, the control module CT outputs the delayed trigger signal DSTBn, to make the output module OT output the delayed source output signal D(n) to the pixel circuits 106. As a result, it is feasible to align the gate signal G(d)-n with the source output signal D(n), thus reducing operational errors of the display device 10.

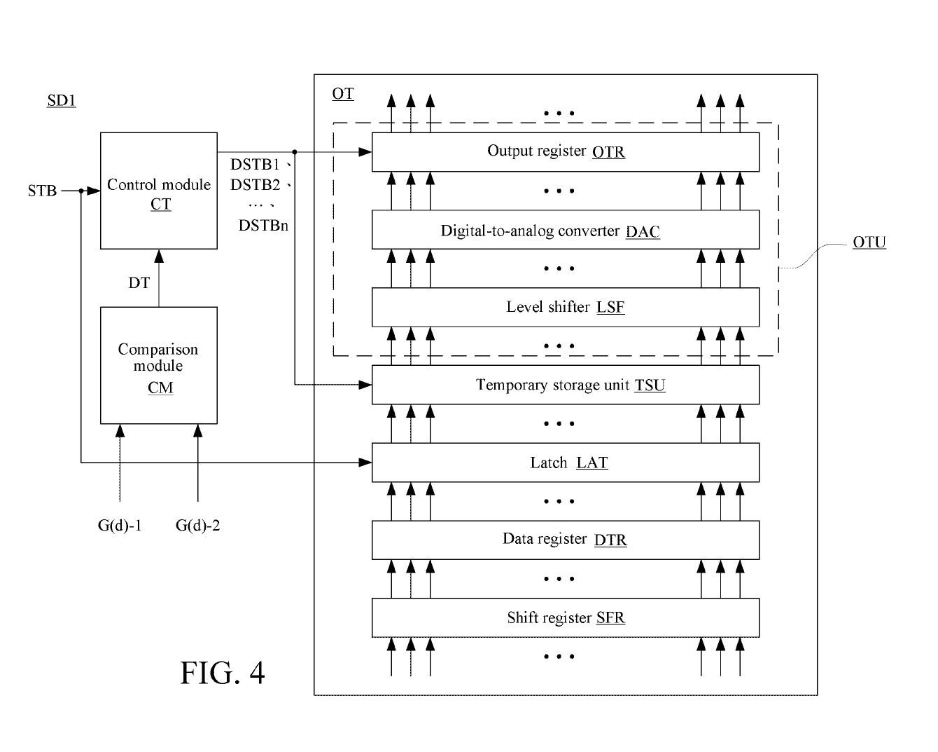

In addition, in other embodiments, the gate driver 40 can be integrated into the source drivers SD1, SD2, . . . , SDm. As a result, the trigger signal STB may be generated inside the source drivers SD1, SD2, . . . , SDm, and thus it is not necessary to receive the trigger signal STB from the outside as the embodiment shown in FIG. 3 and FIG. 4.

Further referring to FIG. 4, in one embodiment, the output module OT further includes a shift register SFR, a data register DTR, a latch LAT, a temporary storage unit TSU and an output unit OTU. The shift register SFR and the data register DTR are used for providing an original source output signal to the latch LAT. The latch LAT is used for temporarily storing the original source output signal, and outputting the original source output signal corresponding to the original trigger signal STB. The temporary storage unit TSU is used for receiving and temporarily storing an original source output signal from the latch LAT, and used for sequentially outputting the original source output signal to the delayed trigger signals DSTB1, DSTB2, . . . , DSTBn. By means of setting of the temporary storage unit TSU, it is feasible to reduce that the previous original source output signal in the latch LAT is covered by the secondary original source output signal due to delaying output of the original source output signals.

In this embodiment, the output unit OTU is used for receiving the original source output signals from the temporary storage unit TSU, and used for sequentially outputting the original source output signals corresponding to the delayed trigger signals DSTB1, DSTB2, . . . , DSTBn, to serve as the delayed source output signals D(1), D(2), . . . , D(M). Furthermore, the output unit OTU may include a level shifter LSF, a digital-to-analog converter DAC, and an output register OTR. In this embodiment, the level shifter LSF is used for converting the original source output signals to appropriate potentials, the digital-to-analog converter DAC is used for converting the digital original source output signals to analog signals, and the output register OTR is used for sequentially outputting the original source output signals corresponding to the delayed trigger signals DSTB1, DSTB2, . . . , DSTBn, to serve as the delayed source output signals D(1), D(2), . . . , D(M).

Operations of the source drivers SD2, . . . , SDm are similar to the source driver SD1, and thus are not repeated herein.

By means of the above setting, the source drivers SD1, SD2, . . . , SDm can output the source output signals D(1), D(2), . . . , D(M) to the pixel circuits 106 corresponding to the delayed gate signals G(d)-1, G(d)-2, . . . , G(d)-m+1, to reduce operational errors of the display device 10.

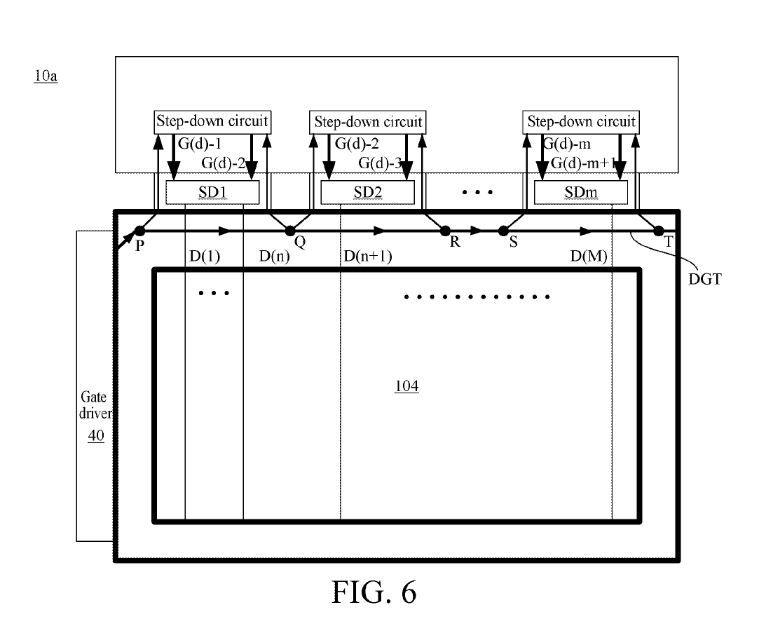

FIG. 6 is a schematic diagram of a display device 10a drawn according to one embodiment of the present application. In this embodiment, the display device 10a is substantially the same as the display device 10, and thus only the differences are described below.

In this embodiment, the display device 10a replaces the gate line equivalent circuit EOC in the display device 10 with a dummy gate line DGT. The transmitting delay of the gate signal on the DGT is substantially the same as that of the gate signal on other gate lines. In this embodiment, the gate driver 40 can output the gate signal to the DGT. The gate signal is delayed on the DGT, wherein signals of different nodes (e.g., nodes P, Q, R, S, T) on the DGT are transmitted to the source drivers SD1, SD2, . . . , SDm through a step-down circuit, to serve as the delayed gate signals G(d)-1, G(d)-2, . . . , G(d)-m+1. For example, the signal of the node P on the DGT can serve as the delayed gate signal G(d)-1, the signal of the node Q on the DGT can serve as the delayed gate signal G(d)-2, the signal of the node R on the DGT can serve as the delayed gate signal G(d)-3, the signal of the node S on the DGT can serve as the delayed gate signal G(d)-m, and the signal of the node T on the DGT can serve as the delayed gate signal G(d)-m+1.

Afterwards, the source drivers SD1, SD2, . . . , SDm can perform corresponding operations according to the delayed gate signals G(d)-1, G(d)-2, . . . , G(d)-m+1. Reference can be made to the foregoing paragraphs for details, which are not repeated herein.

In one embodiment, the step-down circuit may also be integrated into the source drivers SD1, SD2, . . . , SDm, and thus the present application is not limited to the illustration in FIG. 6.

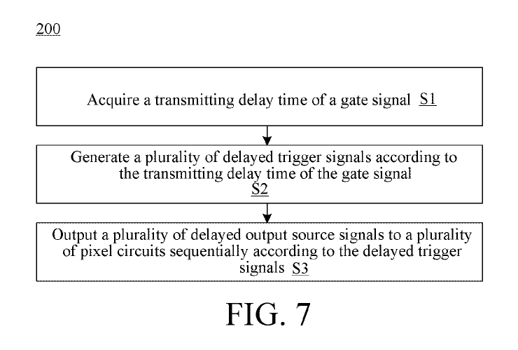

FIG. 7 is a flowchart of a delay method 200 of a source output signal drawn according to one embodiment of the present application.

The delay method 200 of a source output signal may be applied to the display device identical with or similar to the structure shown in FIG. 1. To make the description simple, the delay method 200 of a source output signal is described below by taking the display device 10 in FIG. 1 as an example according to one embodiment of the present invention, but the present invention is limited to the application.

In addition, it should be understood that, for the steps of the delay method 200 of a source output signal mentioned in the implementation mode, unless the sequence is specifically stated, the sequence can be adjusted according to actual requirements, and even the steps can be performed simultaneously or partially simultaneously.

Moreover, in different embodiments, the steps may also be increased, replaced and/or omitted correspondingly.

In this embodiment, the delay method 200 of a source output signal includes the following steps.

In step S1, the source drivers SD1, SD2, . . . , SDm respectively acquire a transmitting delay time of a gate signal. In one embodiment, the transmitting delay time may correspond to the delay time signal DT in FIG. 5.

In step S2, the source drivers SD1, SD2, . . . , SDm generate a plurality of delayed trigger signals DSTB1, DSTB2, . . . , DSTBmn respectively according to the transmitting delay time of the gate signal.

In step S3, the source drivers SD1, SD2, . . . , SDm output delayed source output signals D(1), D(2), . . . , D(M) to a plurality of pixel circuits 106 sequentially according to the delayed trigger signals DSTB1, DSTB2, . . . , DSTBmn.

Reference can be made to the foregoing paragraphs for specific details of the steps, which are thus not repeated herein.

Referring to FIG. 1 and FIG. 5, in another embodiment of the present application, the drive method of the display device 10 may include the following steps. A gate signal is received, for example, the gate signal G(d)-1 of FIG. 5, and a rising edge and a falling edge of the gate signal G(d)-1 are detected respectively; when a voltage corresponding to the rising edge reaches a threshold voltage vth, a pixel voltage is output to the active region 104, wherein the pixel voltage is a source output signal D(n). When a voltage corresponding to the falling edge reaches the threshold voltage vth, outputting the pixel voltage to the active region is stopped.

By means of the above operations, the source drivers SD1, SD2, . . . , SDm can output source output signals D(1), D(2), . . . , D(M) to pixel circuits 106 corresponding to the delayed gate signals G(d)-1, G(d)-2, . . . , G(d)-m+1, to reduce operational errors of the display device 10.

Although the present invention has been disclosed as above with embodiments, the embodiments are not used to limit the present invention. Any person skilled in the art can make various changes and modifications without departing from the spirit and scope of the present invention, and thus the protection scope of the present invention should be subject to the scope defined by the appended claims.

What is claimed is:

1. A source driver of a display device, comprising:
a comparison module for receiving a transmitting delay time of a gate signal;
a control module for generating a plurality of delayed trigger signals according to the transmitting delay time of the gate signal; and
an output module for outputting a plurality of delayed source output signals to a plurality of pixel circuits sequentially according to the delayed trigger signals.

2. The source driver according to claim 1, wherein the control module comprises:
a processing unit for dividing the transmitting delay time of the gate signal into a plurality of divided delay times; and
a synthesis unit for delaying an original trigger signal according to the divided delay times, to generate the delayed trigger signals.

3. The source driver according to claim 1, wherein the output module further comprises:
a temporary storage unit for receiving and temporarily store a plurality of original source output signals and further for sequentially outputting the original source output signals corresponding to the delayed trigger signals; and
an output unit for receiving the original source output signals from the temporary storage unit and for sequentially outputting the original source output signals corresponding to the delayed trigger signals to serve as the delayed source output signals.

4. A display device, comprising:
a plurality of pixel circuits;
a gate driver for outputting a gate signal; and
a plurality of source drivers, wherein at least one of the source drivers comprises:
a comparison module for receiving a transmitting delay time of the gate signal;
a control module for generating a plurality of delayed trigger signals according to the transmitting delay time of the gate signal; and
an output module for outputting a plurality of delayed source output signals to the pixel circuits sequentially according to the delayed trigger signals.

5. The display device according to claim 4, further comprising a dummy gate line or a gate line equivalent circuit, wherein the comparison module compares the gate signal at different positions in the dummy gate line or the gate line equivalent circuit, to acquire the transmitting delay time of the gate signal.

6. The display device according to claim 4, wherein the control module comprises:
a processing unit for dividing the transmitting delay time of the gate signal into a plurality of divided delay times; and
a synthesis unit for receiving an original trigger signal, and delaying a trigger signals according to the divided delay times respectively, to generate the delayed trigger signals.

7. The display device according to claim 4, wherein the output module further comprises:
a temporary storage unit for receiving and temporarily store a plurality of original source output signals, and for sequentially outputting the original source output signals corresponding to the delayed trigger signals; and
an output unit for receiving the original source output signals from the temporary storage unit, and for sequentially outputting the original source output signals corresponding to the delayed trigger signals, to serve as the delayed source output signals.

8. A source driver of a display device, comprising:
a comparison module for receiving a transmitting delay time of a gate signal;
a control module for obtaining an estimated time point when a rising edge of the gate signal reaches a first threshold on an operating point of a gate line according to the transmitting delay time of the gate signal; and
an output module for outputting a delayed source output signal to a pixel circuit at the estimated time point;
wherein the pixel circuit is turned on corresponding to the gate signal on the operating point of the gate line, to be charged according to the delayed source output signal.

9. The source driver according to claim 8, wherein the control module comprises:
a processing unit for dividing the transmitting delay time of the gate signal into a plurality of divided delay times; and
a synthesis unit for receiving an original trigger signal, and delaying the original trigger signal according to one of the divided delay times which corresponds to the operating point, to generate a delayed trigger signal;
wherein the delayed trigger signal corresponds to the estimated time point.

10. A drive method of a display device, for driving a display, the method comprising:
receiving a gate signal, for detecting a rising edge and a falling edge of the gate signal; and
outputting a pixel voltage to the display when a voltage corresponding to the rising edge reaches a threshold voltage.

11. The drive method according to claim 10, further comprising:
stopping outputting the pixel voltage to the display when a voltage corresponding to the falling edge reaches the threshold voltage.
